(19) United States
(12) Patent Application Publication
(10) Pub. No.: US 2025/0125898 A1
(43) Pub. Date: Apr. 17, 2025

(54) WIRELESS DEVICE CAPABILITY OF NEW RADIO 1024-QUADRATURE AMPLITUDE MODULATION

(71) Applicant: Telefonaktiebolaget LM Ericsson (publ), Stockholm (SE)

(72) Inventors: Ajit NIMBALKER, Dublin, CA (US); Ravikiran NORY, San Jose, CA (US); Lian ARAUJO, Solna (SE)

(21) Appl. No.: 18/695,419

(22) PCT Filed: Oct. 3, 2022
(86) PCT No.: PCT/EP2022/077453

§ 371 Date: Mar. 26, 2024

Related U.S. Application Data
(60) Provisional application No. 63/251,449, filed on Oct. 1, 2021.

(51) Int. Cl. H04L 1/00; H04L 27/26; H04W 76/20

(52) U.S. Cl. CPC H04L 1/0003; H04L 27/2613; H04W 76/20

(57) ABSTRACT

A method, network node and wireless device (WD) for providing WD capability for New Radio (NR) 1024-quadrature amplitude modulation (QAM) are disclosed. According to one aspect, a method in a network node includes receiving from the WD an indication of one of a first scaling factor corresponding to a first modulation order and a first data rate, and a second scaling factor corresponding to a second modulation order and a second data rate. The method also includes selecting one of the first modulation order and the second modulation order based at least in part on the indicated one of the first scaling factor and the second scaling factor. The method further includes transmitting to the WD a control message, the control message indicating the selected one of the first and second modulation order and a corresponding one of the first and second data rate.

### TECHNICAL FIELD

The present disclosure relates to wireless communications, and in particular, to wireless device (WD) capability for New Radio (NR) 1024-quadrature amplitude modulation (QAM).

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. Sixth Generation (6G) wireless communication systems are also under development.

Wireless communication systems according to the 3GPP may include the following channels:
A physical downlink control channel, PDCCH;
A physical uplink control channel, PUCCH;
A physical downlink shared channel, PDSCH;
A physical uplink shared channel, PUSCH;
A physical broadcast channel, PBCH; and
A physical random access channel, PRACH.

The New radio (NR) standard of the 3GPP is being designed to provide service for multiple use cases such as enhanced mobile broadband (eMBB), ultra-reliable and low latency communication (URLLC), and machine type communication (MTC). Each of these services has different technical requirements. For example, the general requirement for eMBB is high data rate with moderate latency and moderate coverage, while URLLC service requires a low latency and high reliability transmission but perhaps for moderate data rates.

One of the solutions for low latency data transmission is shorter transmission time intervals. In NR in addition to transmission in a slot, a mini-slot transmission is also allowed to reduce latency. A mini-slot may consist of any number of 1 to 14 orthogonal frequency division multiplexed (OFDM) symbols. It should be noted that the concepts of slot and mini-slot are not specific to a specific service meaning that a mini-slot may be used for either eMBB, URLLC, or other services.

NR supports enhanced data rate support via incorporation of advanced features including wider carrier bandwidths (up to 100 MHz in FR1, and up to 400 MHz in FR2), higher order MIMO (2, 4 or 8 layers for a WD on the downlink, up to 4-layers on the uplink), carrier aggregation of carriers in FR1 and/or FR2, as well as modulation orders such as 64-QAM and 256-QAM.

Enabling 1024-QAM can further increase peak throughputs and/or spectral efficiency. It can be used to enhance network and WD throughput in scenarios with sufficiently higher signal to interference plus noise ratio (SINR and better channel conditions. Current 3GPP NR Technical Releases 15 and 16 (3GPP Rel-15/16) do not support 1024-QAM.

LTE Rel-15 specified support of 1024-QAM modulation for the downlink. The specification includes the description of 1024-QAM constellation, a channel quality indicator (CQI) table corresponding to 1024-QAM, as well as a modulation and coding scheme (MCS) table for 1024-QAM. The MCS table provides a mapping between an MCS index to modulation order and a transport block size (which is derived from a lookup table using a transport block size and resource block (RB) index). The specification also includes higher layer signaling via a parameter that enables use of 1024-QAM for PDSCH that is assigned by a PDCCH/EPDCCH with downlink control information (DCI) format 1/1B/1D/2/2A/2B/2C/2D with cyclic redundancy code (CRC) scrambled by a C-radio network temporary identifier (RNTI). For example, LTE specifies a six-bit modulation and coding scheme (MCS) table.

Unlike LTE, the NR MCS table uses a mapping between an MCS index to modulation order and a coding rate. Thus, the LTE 1024-QAM MCS table cannot be directly reused for NR 1024-QAM design.

NR supports different non-fallback DCI formats such as 1-1 and 1-2, each of which may have separate configurations, including for fields and corresponding field sizes.

In NR, downlink transport blocks are encoded using low density parity check (LDPC) code and each transport block is rate-matched based on a reference transport block size (known as transport block size limited buffer rate matching (TBSLBRM))) that is derived based on multiple higher layer signaling parameters, including a bandwidth (number of physical resource blocks (PRBs)), number of layers, a modulation order. This is specified in 3GPP Technical Standard/Specification 38.212, 5.4.2.1.

In NR, a phase tracking reference signal (RS) can be configured for uplink and downlink transmissions, and the time/frequency density is typically configured based on WD reported values (e.g., MCS index range and associated densities) based on the MCS table assumed using the maximum modulation order. For example, a 3GPP Rel-15/16 WD may indicate this capability based on the 256-QAM MCS table if that WD supported 256-QAM for the band via ptrs-DensityRecommendationSetDL.

In 3GPP NR Rel-15/16, WD reports support of a maximum modulation order of 256-QAM as a per-WD capability for FR1, or per-band capability for FR2. Apart from this, the WD reports additional capabilities related to data rate that it supports via the scalingFactor that is signaled per-band-per-band combination (or per Feature set), and supportedModulationOrderDL that is signaled per-component carrier-per-band-per-band combination (or feature set per CC).

| | | | | |
|---|---|---|---|---|
| pdsch-256QAM-FR1 | UE | Yes | No | FR1 |
| Indicates whether the WD supports 256QAM modulation | | | | only |
| scheme for PDSCH for FR1 as defined in 7.3.1.2 of TS | | | | |
| 38.211 [6]. | | | | |
| pdsch-256QAM-FR2 | Band | No | N/A | FR2 |
| Indicates whether the WD supports 256QAM modulation | | | | only |
| scheme for PDSCH for FR2 as defined in 7.3.1.2 of TS | | | | |
| 38.211 [6]. | | | | |
| scalingFactor | FS | No | N/A | N/A |
| Indicates the scaling factor to be applied to the band in the | | | | |
| max data rate calculation as defined in 4.1.2. Value f0p4 | | | | |
| indicates the scaling factor 0.4, f0p75 indicates 0.75, and so | | | | |
| on. If absent, the scaling factor 1 is applied to the band in | | | | |
| the max data rate calculation. | | | | |
| supportedModulationOrderDL | FSP | No | N/A | N/A |
| Indicates the maximum supported modulation order to be | C | | | |
| applied for downlink in the carrier in the max data rate | | | | |
| calculation as defined in 4.1.2. If included, the network | | | | |
| may use a modulation order on this serving cell which is | | | | |
| higher than the value indicated in this field as long as WD | | | | |
| supports the modulation of higher value for downlink. If | | | | |
| not included: | | | | |
| for FR1, the network uses the modulation order | | | | |
| signalled in pdsch-256QAM-FR1. | | | | |
| for FR2, the network uses the modulation order | | | | |
| signalled per band i.e. pdsch-256QAM-FR2 if signalled. If | | | | |
| not signalled in a given band, the network shall use the | | | | |
| modulation order 64QAM. | | | | |
| In all the cases, it shall be ensured that the data rate does | | | | |
| not exceed the max data rate (DataRate) and max data rate | | | | |
| per CC (DataRateCC) according to TS 38.214 [12]. | | | | |
| ptrs-DensityRecommendationSetDL | Band | CY | N/A | N/A |
| For each supported sub-carrier spacing, indicates preferred | | | | |
| threshold sets for determining DL PTRS density. It is | | | | |
| mandated for FR2. For each supported sub-carrier spacing, | | | | |
| this field comprises: | | | | |
| two values of frequencyDensity, | | | | |
| three values of timeDensity. | | | | |

A WD supported data rate calculation is as follows and this is applicable for up to maximum of 256QAM modulation order as per the 3GPP Rel-15/16 standard (from 3GPP TS 38.306)

For NR, the approximate data rate for a given number of aggregated carriers in a band or band combination is computed as follows:

$$data rate ( in Mbps ) = {10}^{- 6} \cdot {\sum }_{j = 1}^{J} ( {v}_{Layers}^{( j )} \cdot {Q}_{m}^{( j )} \cdot {f}^{( j )} \cdot {R}_{max} \cdot \frac{{N}_{P R B}^{BW ( j ) , μ} \cdot 12}{{T}_{s}^{μ}} \cdot ( 1 - O {H}^{( j )} ) )$$

wherein

J is the number of aggregated component carriers in a band or band combination:

$${R}_{max} = 948 / 1024 ;$$

For the j-th component carrier (CC):
v_{Layers}^{(j)} is the maximum number of supported layers given by higher layer parameter maxNumberMIMO-LayersPDSCH for downlink and maximum of higher layer parameters maxNumberMIMO-LayersCB-PUSCH and maxNumberMIMO-LayersNonCB-PUSCH for uplink;
Qₘ^{(j)} is the maximum supported modulation order given by higher layer parameter supportedModulationOrderDL for downlink and higher layer parameter supportedModulationOrderUL for uplink;
f^{(j)} is the scaling factor given by higher layer parameter scalingFactor and can take the values 1, 0.8, 0.75, and 0.4;
μ is the numerology (as defined in 3GPP TS 38.211);
Tₛ^{μ} is the average OFDM symbol duration in a subframe for numerology μ. i.e.

$${T}_{s}^{μ} = \frac{1 {0}^{- 3}}{14 \cdot {2}^{μ}} .$$

Note that normal cyclic prefix is assumed;
N_{PRB}^{BW(j)μ} is the maximum RB allocation in bandwidth BW^{(j)} with numerology μ, as defined in 5.3 TS 38.101-1 and 5.3 TS 38.101-2, where BW^{(j)} is the WD supported maximum bandwidth in the given band or band combination;
OH^{(j)} is the overhead and takes the following values:
   0.14, for frequency range FR1 for DL
   0.18, for frequency range FR2 for DL
   0.08, for frequency range FR1 for UL
   0.10, for frequency range FR2 for UL

NOTE 1: Only one of the UL or SUL carriers (the one with the higher data rate) is counted for a cell operating SUL.

NOTE 2: For UL transmit (Tx) switching between carriers, only the supported MIMO layer combination across carriers that results in the highest combined data rate is counted for the carriers in the supported maximum UL data rate.

The approximate maximum data rate can be computed as the maximum of the approximate data rates computed using the above formula for each of the supported band or band combinations.

For single carrier NR SA operation, the WD shall support a data rate for the carrier that is no smaller than the data rate computed using the above formula, with J=1 CC and component v_{Layers}^{(j)}·Qₘ^{(j)}·f^{(j)} is no smaller than 4.

NOTE: As an example, the value 4 in the component above can correspond

$$to {v}_{L a y e r s}^{( j )} = 1 , {Q}_{m}^{( j )} = 4 and {f}^{( j )} = 1 .$$

For evolved universal terrestrial radio access (EUTRA) in case of multi-radio access technology-dual connectivity (MR-DC), the approximate data rate for a given number of aggregated carriers in a band or band combination is computed as follows:

$$Data rate ( in Mbps ) = 1 {0}^{- 3} \cdot {\sum }_{j = 1}^{J} {TBS}_{j}$$

wherein:
J is the number of aggregated EUTRA component carriers in MR-DC band combination;
TBS; is the total maximum number of DL-SCH transport block bits received or the total maximum number of UL-SCH transport block bits transmitted, within a 1 ms transmission time interval (TTI) for j-th CC, as derived from 3GPP Technical Standard (TS) 36.213 based on the WD supported maximum MIMO layers for the j-th CC, and based on the maximum modulation order for the j-th CC and number of PRBs based on the bandwidth of the j-th CC according to indicated WD capabilities.

The approximate maximum data rate can be computed as the maximum of the approximate data rates computed using the above formula for each of the supported band or band combinations.

For MR-DC, the approximate maximum data rate is computed as the sum of the approximate maximum data rates from NR and Evolved Universal Terrestrial Radio Access (EUTRA).

Existing solutions specified in LTE 1024-QAM design and/or NR 256-QAM cannot be fully reused for enabling of 1024-QAM for NR PDSCH, in particular related to the following:
Capability related to PT-RS density recommendation
Handling of capabilities related to data rate calculation such as supportedModulationOrderDL and data rate scaling factor

A network node, e.g., a gNB, can end up with pessimistic (or inaccurate) understanding of these capabilities as legacy networks may apply these capabilities to maximum modulation order of 256-QAM (as in 3GPP Rel-15/16) while 3GPP Rel-17 networks may apply same capability to a maximum modulation order of 1024-QAM. For example, this can lead to an unnecessary reduction in peak rate (e.g., if a 3GPP Rel 17 WD indicates scaling factor of 0.75 assuming maximum modulation order of 1024-QAM, but legacy NW may apply the scaling factor of 0.75 with 256-QAM), etc. Hence, WD performance can become degraded in legacy networks.

### SUMMARY

Some embodiments advantageously provide methods, network nodes and wireless devices for wireless device (WD) capability for New Radio (NR) 1024-quadrature amplitude modulation (QAM).

Some embodiments provide:
a new capability to disambiguate the PT-RS density recommendation when the WD reports support of both 1024-QAM and 256-QAM; and/or
a new capability to disambiguate the data rate scaling factor and/or supportedModulationOrderDL to apply when the WD reports capability of supporting both 1024-QAM and 256-QAM.

According to one aspect, a method in a network node configured to communicate with a WD is provided. The method includes receiving from the WD an indication of one of a first scaling factor and a second scaling factor, the first scaling factor corresponding to a first modulation order and a first data rate, and the second scaling factor corresponding to a second modulation order and a second data rate. The method further includes selecting one of the first modulation order and the second modulation order based at least in part on the indicated one of the first scaling factor and the second scaling factor. The method also includes transmitting to the WD a control message, the control message indicating the selected one of the first and second modulation order and a corresponding one of the first and second data rate.

According to this aspect, in some embodiments, the control message is transmitted by radio resource control, RRC, signaling, the signaling configured to include one of a first parameter and a second parameter, the first parameter indicating 1024 quadrature amplitude modulation, QAM, capability of the WD, the second parameter indicating a different order of modulation. In some embodiments, the method also includes determining a data rate corresponding to the indicated one of the first scaling factor and the second scaling factor. In some embodiments, the method also includes receiving from the WD one of a first phase tracking reference signal, PTRS, density recommendation and a second PTRS density recommendation, the first PTRS density recommendation associated with the first modulation order, the second PTRS density recommendation associated with the second modulation order. In some embodiments, the method also includes transmitting to the WD a set of threshold values corresponding to different subcarrier spacings, SCSs, for determining PTRS density for a physical downlink shared channel, the set of threshold values being associated with one of the first and second modulation order.

According to another aspect, a network node configured to communicate with a WD is provided. The network node includes a radio interface configured to receive from the WD an indication of one of a first scaling factor and a second scaling factor, the first scaling factor corresponding to a first modulation order and a first data rate, and the second scaling factor corresponding to a second modulation order and a second data rate. The network node also includes processing circuitry in communication with the radio interface and configured to select one of the first modulation order and the second modulation order based at least in part on the indicated one of the first scaling factor and the second scaling factor. The radio interface is further configured to transmit to the WD a control message, the control message indicating the selected one of the first and second modulation order and a corresponding one of the first and second data rate.

According to this aspect, in some embodiments, the control message is transmitted by radio resource control, RRC, signaling, the signaling configured to include one of a first parameter and a second parameter, the first parameter indicating 1024 quadrature amplitude modulation, QAM, capability of the WD, the second parameter indicating a different order of modulation. In some embodiments, the processing circuitry is further configured to determine a data rate corresponding to the indicated one of the first scaling factor and the second scaling factor. In some embodiments, the radio interface is further configured to receive from the WD one of a first phase tracking reference signal, PTRS, density recommendation and a second PTRS density recommendation, the first PTRS density recommendation associated with the first modulation order, the second PTRS density recommendation associated with the second modulation order. In some embodiments, the radio interface is further configured to transmit to the WD a set of threshold values corresponding to different subcarrier spacings, SCSs, for determining PTRS density for a physical downlink shared channel, the set of threshold values being associated with one of the first and second modulation order.

According to another aspect, a method in a WD configured to communicate with a network node is provided. The method includes transmitting to the network node an indication of one of a first scaling factor and a second scaling factor, the first scaling factor corresponding to a first modulation order and a first data rate, and the second scaling factor corresponding to a second modulation order and a second data rate. The method also includes receiving a control message, the control message indicating one of the first and second modulation order and corresponding one of the first and second data rate. The method also includes demodulating a physical downlink shared channel using the indicated one of the first and second modulation order.

According to this aspect, in some embodiments, the control message is received by radio resource control, RRC, signaling, the signaling configured to include one of a first parameter and a second parameter, the first parameter indicating 1024 quadrature amplitude modulation, QAM, capability of the WD, the second parameter indicating a different order of modulation. In some embodiments, the method also includes determining a data rate corresponding to the indicated one of the first scaling factor and the second scaling factor. In some embodiments, the method also includes transmitting to the network node one of a first phase tracking reference signal, PTRS, density recommendation and a second PTRS density recommendation, the first PTRS density recommendation associated with the first modulation order, the second PTRS density recommendation associated with the second modulation order. In some embodiments, the method also includes receiving from the network node a set of threshold values corresponding to different subcarrier spacings, SCSs, for determining PTRS density for a physical downlink shared channel, the set of threshold values being associated with one of the first and second modulation order.

According yet another aspect, a WD configured to communicate with a network node is provided. The WD includes a radio interface configured to transmit to the network node an indication of one of a first scaling factor and a second scaling factor, the first scaling factor corresponding to a first modulation order and a first data rate, and the second scaling factor corresponding to a second modulation order and a second data rate. The radio interface is also configured to receive a control message, the control message indicating one of the first and second modulation order and a corresponding one of the first and second data rate. The WD also includes processing circuitry in communication with the radio interface and configured to demodulate a physical downlink shared channel using the indicated one of the first and second modulation order at the corresponding one of the first and second data rate.

According to this aspect, in some embodiments, the control message is received by radio resource control, RRC, signaling, the signaling configured to include one of a first parameter and a second parameter, the first parameter indicating 1024 quadrature amplitude modulation, QAM, capability of the WD, the second parameter indicating a different order of modulation. In some embodiments, the processing circuitry is further configured to determine a data rate corresponding to the indicated one of the first scaling factor and the second scaling factor. In some embodiments, the radio interface is further configured to transmit to the network node one of a first phase tracking reference signal, PTRS, density recommendation and a second PTRS density recommendation, the first PTRS density recommendation associated with the first modulation order, the second PTRS density recommendation associated with the second modulation order. In some embodiments, the radio interface is further configured to receive from the network node a set of threshold values corresponding to different subcarrier spacings, SCSs, for determining PTRS density for a physical downlink shared channel, the set of threshold values being associated with one of the first and second modulation order.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system connected via an intermediate network to a host computer according to the principles in the present disclosure;

FIG. 2 is a block diagram of a host computer communicating via a network node with a wireless device over an at least partially wireless connection according to some embodiments of the present disclosure;

FIG. 3 is a flowchart illustrating example methods implemented in a communication system including a host computer, a network node and a wireless device for executing a client application at a wireless device according to some embodiments of the present disclosure;

FIG. 4 is a flowchart illustrating example methods implemented in a communication system including a host computer, a network node and a wireless device for receiving user data at a wireless device according to some embodiments of the present disclosure;

FIG. 5 is a flowchart illustrating example methods implemented in a communication system including a host computer, a network node and a wireless device for receiving user data from the wireless device at a host computer according to some embodiments of the present disclosure;

FIG. 6 is a flowchart illustrating example methods implemented in a communication system including a host computer, a network node and a wireless device for receiving user data at a host computer according to some embodiments of the present disclosure;

FIG. 7 is a flowchart of an example process in a network node for wireless device (WD) capability for New Radio (NR) 1024-quadrature amplitude modulation (QAM);

FIG. 8 is a flowchart of an example process in a wireless device for wireless device (WD) capability for New Radio (NR) 1024-quadrature amplitude modulation (QAM);

FIG. 9 is a flowchart of another example process in a network node for wireless device (WD) capability for New Radio (NR) 1024-quadrature amplitude modulation (QAM); and

FIG. 10 is a flowchart of another example process in a wireless device for wireless device (WD) capability for New Radio (NR) 1024-quadrature amplitude modulation (QAM).

### DETAILED DESCRIPTION

Before describing in detail example embodiments, it is noted that the embodiments reside primarily in combinations of apparatus components and processing steps related to wireless device (WD) capability for New Radio (NR) 1024-quadrature amplitude modulation (QAM). Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide wireless device (WD) capability for New Radio (NR) 1024-quadrature amplitude modulation (QAM). Some embodiments allow a WD to signal capabilities for 1024-QAM and 256-QAM independently so that the WD performance may be optimized in both legacy networks and in networks implementing the 1024-QAM feature.

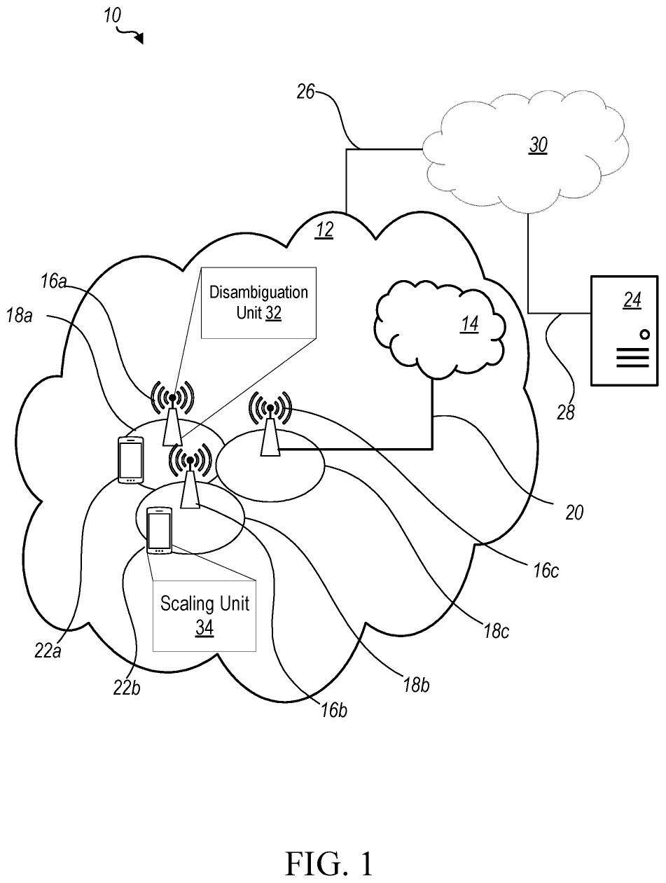

Referring to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a disambiguation unit 32 which is configured to perform one or more network node 16 functions as described herein such as to select one of a first modulation order and a second modulation order based at least in part on the indicated one of a first scaling factor and a second scaling factor. The disambiguation unit 32 may further be configured to disambiguate a phase tracking reference signal, PTRS, based on the first indication and the second indication. A wireless device 22 is configured to include a scaling unit 34 which is configured to perform one or more wireless device 22 functions as described herein such as applying a scaling factor based at least in part on an indication of one of a first scaling factor and a second scaling factor, the first scaling factor corresponding to a first modulation order and a first data rate, and the second scaling factor corresponding to a second modulation order and a second data rate. The scaling unit 34 may further be configured to apply a scaling factor for performing QAM.

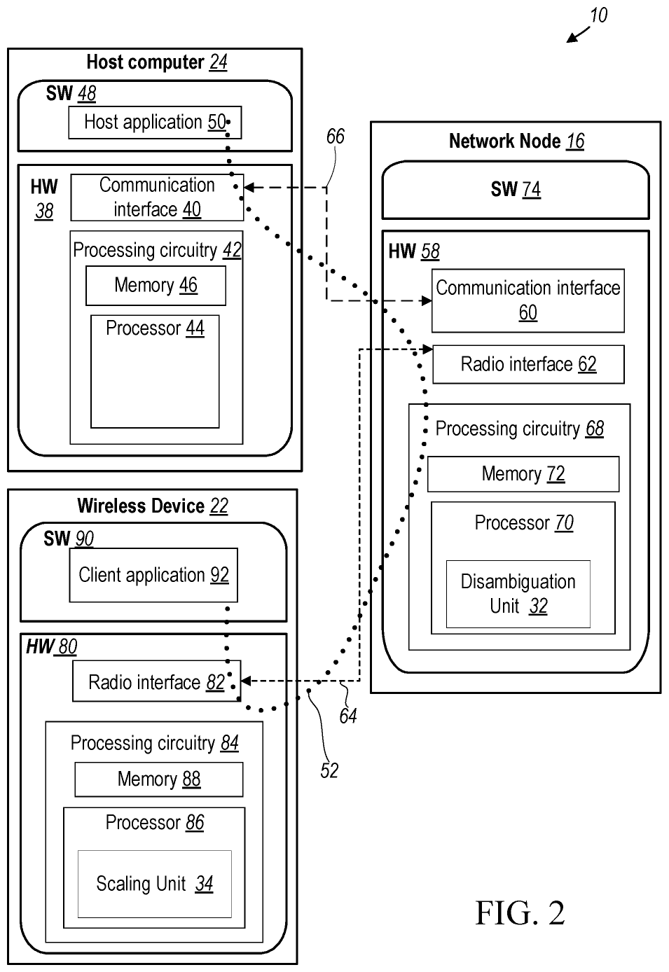

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory)

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include disambiguation unit 32 which is configured to select one of a first modulation order and a second modulation order based at least in part on the indicated one of a first scaling factor and a second scaling factor. The disambiguation unit 32 may further be configured to disambiguate a phase tracking reference signal, PTRS, based on the first indication and the second indication.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include scaling unit 34 which is configured to apply a scaling factor based at least in part on an indication of one of a first scaling factor and a second scaling factor, the first scaling factor corresponding to a first modulation order and a first data rate, and the second scaling factor corresponding to a second modulation order and a second data rate. The scaling unit 34 may further be configured to apply a scaling factor for performing QAM.

In some embodiments, the inner workings of the network node 16, WD 22, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or

preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1 and 2 show various “units” such as disambiguation unit 32, and scaling unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

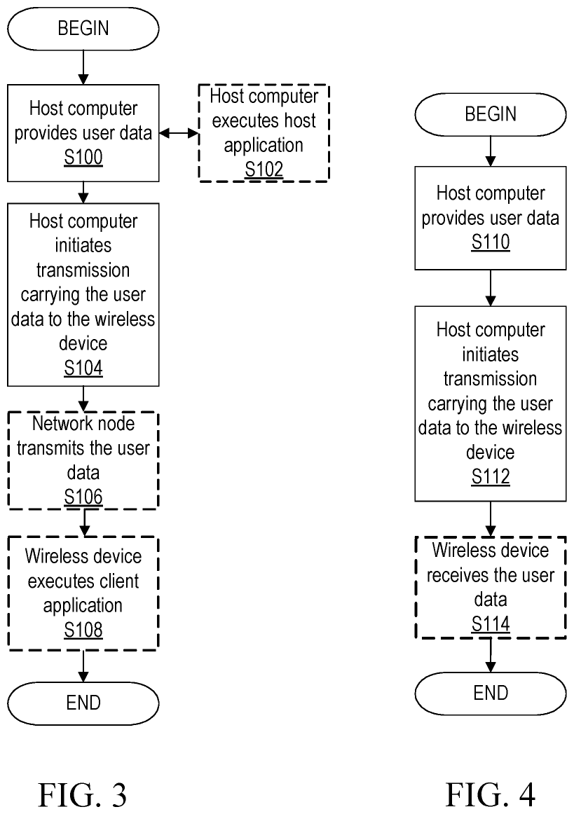

FIG. 3 is a flowchart illustrating an example method implemented in a communication system, such as, for example, the communication system of FIGS. 1 and 2, in accordance with one embodiment. The communication system may include a host computer 24, a network node 16 and a WD 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 4 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

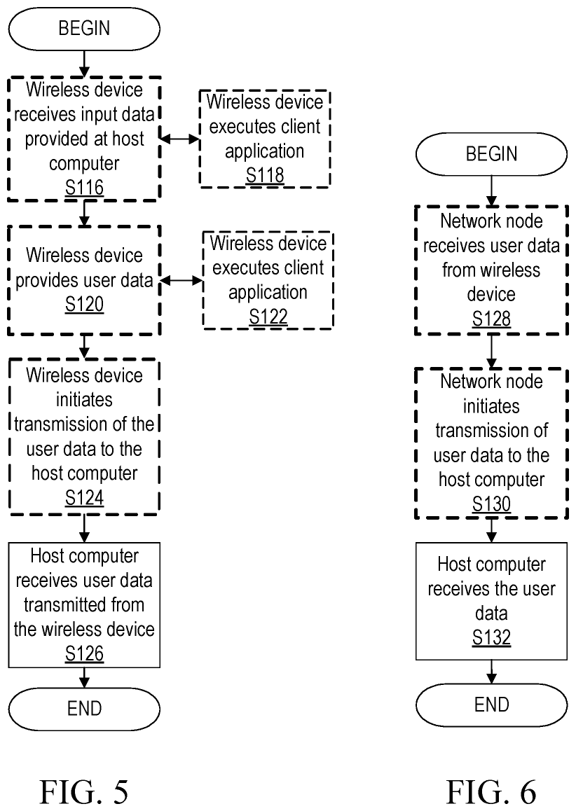

FIG. 5 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 6 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

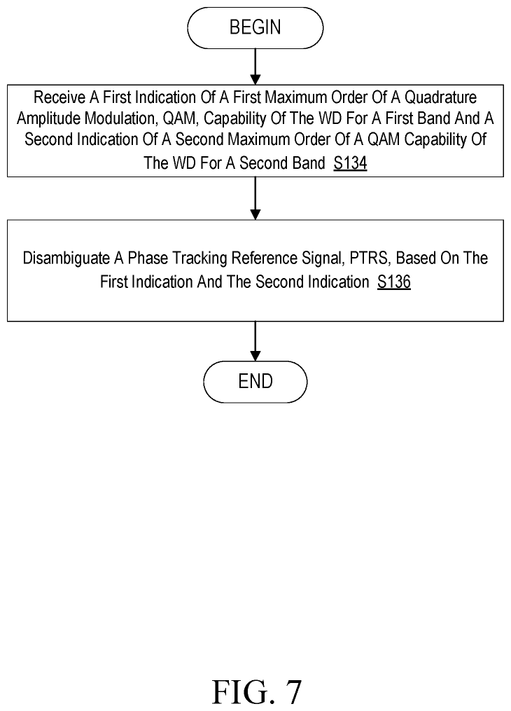

FIG. 7 is a flowchart of an example process in a network node 16 for wireless device (WD) capability for New Radio (NR) 1024-quadrature amplitude modulation (QAM). One or more blocks described herein may be performed by one or more elements of network node 16 such as by one or more of processing circuitry 68 (including the disambiguation unit 32), processor 70, radio interface 62 and/or communication interface 60. Network node 16 is configured to receive a first indication of a first maximum order of a quadrature amplitude modulation, QAM, capability of the WD for a first band and a second indication of a second maximum order of a QAM capability of the WD for a second band (Block S134). The process also includes disambiguating a phase tracking reference signal, PTRS, based on the first indication and the second indication (Block S136).

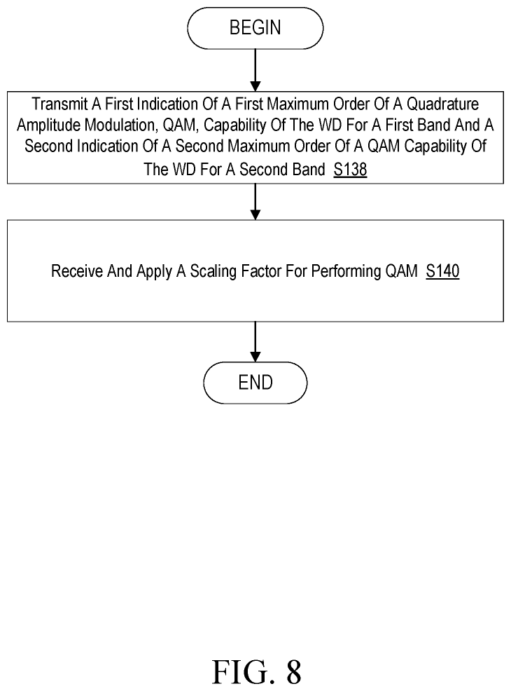

FIG. 8 is a flowchart of an example process in a wireless device 22 according to some embodiments of the present disclosure. One or more blocks described herein may be performed by one or more elements of wireless device 22 such as by one or more of processing circuitry 84 (including the scaling unit 34), processor 86, radio interface 82 and/or communication interface 60. Wireless device 22 is configured to transmit a first indication of a first maximum order of a quadrature amplitude modulation, QAM, capability of the WD for a first band and a second indication of a second maximum order of a QAM capability of the WD for a second band (Block S138). The process also includes receiving and applying a scaling factor for performing QAM (Block S140).

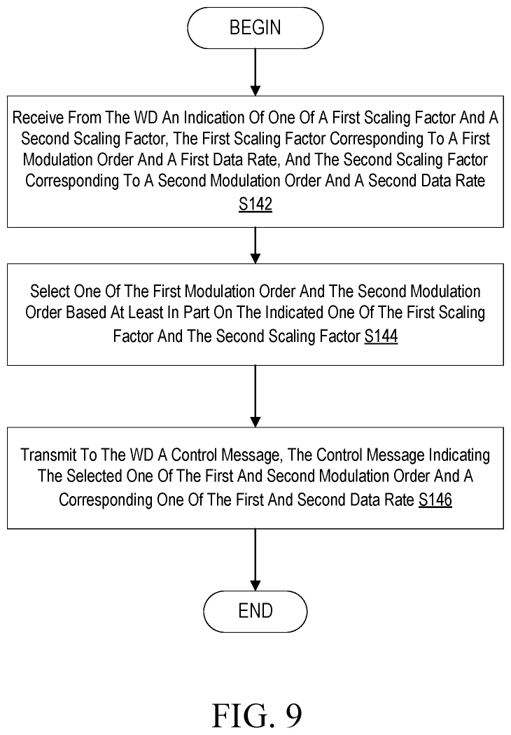

FIG. 9 is a flowchart of an example process in a network node 16 for wireless device (WD) capability for New Radio (NR) 1024-quadrature amplitude modulation (QAM). One or more blocks described herein may be performed by one or more elements of network node 16 such as by one or more of processing circuitry 68 (including the disambiguation unit 32), processor 70, radio interface 62 and/or communication interface 60. Network node 16 is configured to receive from the WD 22 an indication of one of a first scaling factor and a second scaling factor, the first scaling factor corresponding to a first modulation order and a first data rate, and the second scaling factor corresponding to a second modulation order and a second data rate (Block S142). The method also includes selecting one of the first modulation order and the second modulation order based at least in part on the indicated one of the first scaling factor and the second scaling factor (Block S144). The process also includes transmitting to the WD 22 a control message, the control message indicating the selected one of the first and second modulation order and a corresponding one of the first and second data rate (Block S146).

In some embodiments, the control message is transmitted by radio resource control, RRC, signaling, the signaling configured to include one of a first parameter and a second parameter, the first parameter indicating 1024 quadrature amplitude modulation, QAM, capability of the WD, the second parameter indicating a different order of modulation. In some embodiments, the method also includes determining a data rate corresponding to the indicated one of the first scaling factor and the second scaling factor. In some embodiments, the method also includes receiving from the WD one of a first phase tracking reference signal, PTRS, density recommendation and a second PTRS density recommendation, the first PTRS density recommendation associated with the first modulation order, the second PTRS density recommendation associated with the second modulation order. In some embodiments, the method also includes transmitting to the WD a set of threshold values corresponding to different subcarrier spacings, SCSs, for determining PTRS density for a physical downlink shared channel, the set of threshold values being associated with one of the first and second modulation order.

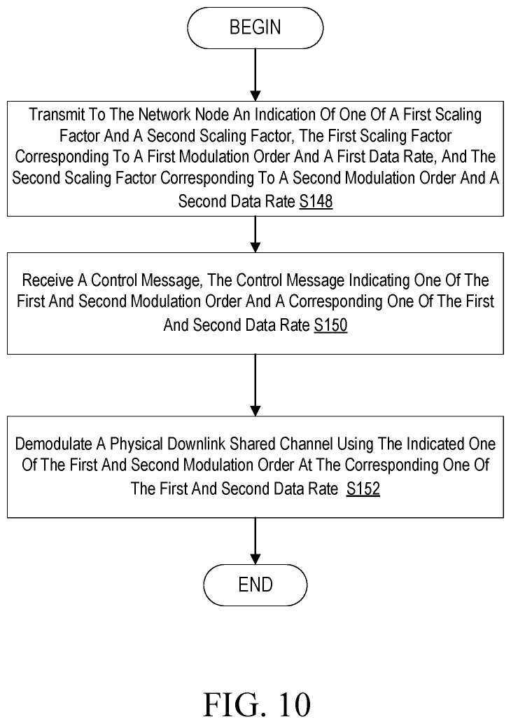

FIG. 10 is a flowchart of an example process in a wireless device 22 according to some embodiments of the present disclosure. One or more blocks described herein may be performed by one or more elements of wireless device 22 such as by one or more of processing circuitry 84 (including the scaling unit 34), processor 86, radio interface 82 and/or communication interface 60. Wireless device 22 is configured to transmit to the network node 16 an indication of one of a first scaling factor and a second scaling factor, the first scaling factor corresponding to a first modulation order and a first data rate, and the second scaling factor corresponding to a second modulation order and a second data rate (Block S148). The process also includes receiving a control message, the control message indicating one of the first and second modulation order and corresponding one of the first and second data rate (Block S150). The method also includes demodulating a physical downlink shared channel using the indicated one of the first and second modulation order (Block S152).

In some embodiments, the control message is received by radio resource control, RRC, signaling, the signaling configured to include one of a first parameter and a second parameter, the first parameter indicating 1024 quadrature amplitude modulation, QAM, capability of the WD 22, the second parameter indicating a different order of modulation. In some embodiments, the method includes determining a data rate corresponding to the indicated one of the first scaling factor and the second scaling factor. In some embodiments, the method also includes transmitting to the network node 16 one of a first phase tracking reference signal, PTRS, density recommendation and a second PTRS density recommendation, the first PTRS density recommendation associated with the first modulation order, the second PTRS density recommendation associated with the second modulation order. In some embodiments, the method also includes receiving from the network node 16 a set of threshold values corresponding to different subcarrier spacings, SCSs, for determining PTRS density for a physical downlink shared channel, the set of threshold values being associated with one of the first and second modulation order.

Having described the general process flow of arrangements of the disclosure and having provided examples of hardware and software arrangements for implementing the processes and functions of the disclosure, the sections below provide details and examples of arrangements for wireless device (WD) capability for New Radio (NR) 1024-quadrature amplitude modulation (QAM).

Some embodiments disclosed herein may be applied to any case where there is need to disambiguate between what the WD 22 supports for 1024-QAM and 256-QAM.

In some embodiments, a WD 22 reports a first capability associated with a first maximum modulation order in a first band. The WD 22 may also report a second capability associated with a second maximum modulation order for the first band. The first capability is a phase tracking reference signal (PTRS) density recommendation based on an MCS table corresponding to a first modulation order which is one of 64-QAM and 256-QAM. The second capability is a PTRS density recommendation based on a MCS table corresponding to the second maximum modulation order which can be 1024-QAM. The WD 22 may be configured with 1024-QAM for downlink data transmission (e.g., a 1024-QAM based MCS table), and the WD 22 may be configured with an IE phase TrackingRS in DMRS-DownlinkConfig, which configures the higher layer parameters timeDensity and frequencyDensity in PTRS-DownlinkConfig indicating threshold values used to detect the PTRS. The indicated threshold values are based on the second capability. When the WD 22 receives a control message scheduling downlink data, the WD 22 decodes the downlink data according to the control message and based on the indicated threshold values for PTRS.

In some embodiments, a WD 22 may report a first capability associated with a first maximum modulation order in a first band. The first capability is a PTRS density recommendation based on a MCS table corresponding to a first maximum modulation order which can be 1024-QAM. The WD 22 may be configured with 1024-QAM for downlink data transmission on at least one carrier in the band, and the WD 22 is configured with an IE phase TrackingRS in DMRS-DownlinkConfig, which configures, the higher layer parameters timeDensity and frequencyDensity in PTRS-DownlinkConfig indicating the threshold values, wherein the indicated threshold values are based on the first capability. When the WD 22 receives a control message scheduling downlink data, the WD 22 decodes the downlink data according to the control message and based on the indicated threshold values for PTRS.

The PTRS density recommendation capability for 1024-QAM may be as described below. The three values are selected from 0 to 26 for the MCS indices from a 1024-QAM table with explicit modulation and coding scheme indication.
Downlink PTRS density recommendation for 1024QAM:
   Preferred threshold sets, TSi for determine PTRS density for PDSCH with maximum modulation order of 1024QAM, candidate value range is the same as that of downlink PTRS RRC configuration:
      i is the index of SCS, i=1,2,3 corresponding to 15,30.60 kHz SCS;
   Per-band signaling;
   For each TSi, it composes of two values each selected from {1 . . . 276} for frequency density, and three values each selected from {0 . . . 26} for time density;

ptrs-DensityRecommendationSetDL {
frequencyDensity1
frequencyDensity2
timeDensity1
timeDensity2
timeDensity3
}

In some embodiments, a WD 22 may report a first capability indicating a scaling factor value associated with a first data rate calculation associated with a first maximum modulation order for a band in a band combination. The WD 22 may report a second capability indicating a second scaling factor value associated with a second data rate calculation associated with a second maximum modulation order for the band in a band combination. The first capability is a scaling factor value corresponding to a first modulation order which is one of {pi/2-BPSK, QPSK, 16-QAM, 64-QAM and 256-QAM}. The second capability is a scaling factor value corresponding to the second maximum modulation order which can be 1024-QAM. The WD 22 may be configured with 1024-QAM for downlink data transmission (e.g., a 1024-QAM based MCS table) on at least one carrier in the band. When the WD 22 receives a control message scheduling downlink data, the WD 22 decodes the downlink data according to the control message, wherein the control message is in according with the second data rate calculated.

The scaling factor capability for 1024-QAM can be described as below:
scalingFactor for 1024QAM:
Indicates the scaling factor to be applied to the band in the max data rate calculation as defined in 4.1.2 when [pdsch-1024QAM-FR1] is signaled for the band;
   Value f0p4 indicates the scaling factor 0.4, f0p75 indicates 0.75, and so on. If absent, the scaling factor 1 is applied to the band in the max data rate calculation; and/or
   Can be per-band-per band combination signaling.

In some embodiments, a WD 22 may report a first capability indicating a first maximum modulation order for a band in a band combination. The first capability indicates support of a first maximum modulation order which can be 1024-QAM. The WD 22 may also support a first data rate based on a second parameter supportedModulationDL wherein the second parameter supportedModulationDL takes a value equal to 1024QAM when WD 22 indicates support of 1024QAM for the band. The WD 22 is configured with 1024-QAM for downlink data transmission (e.g., a 1024-QAM based MCS table) on at least one carrier in the band. When the WD 22 receives a control message scheduling downlink data, the WD 22 decodes the downlink data according to the control message at the second calculated data rate.

A corresponding text proposal to update the supported maximum data rate calculation is shown below, wherein the proposed changes are in bold underline. However, it is understood each of the following change could be separately applied.
Qₘ^{(j)} is the maximum supported modulation order given by higher layer parameter supportedModulationOrderDL for downlink and higher layer parameter supportedModulationOrderUL for uplink, wherein supportedModulationDL=1024QAM when WD 22 indicates 1024QAM support for a band;
f^{(j)} is the scaling factor given by higher layer parameter scalingFactor 1024-r17 if (pdsch-1024QAM-FR1] is signalled and by higher layer parameter scaling Factor otherwise.

For NR, the approximate data rate for a given number of aggregated carriers in a band or band combination is computed as follows:

$$data rate ( in Mbps ) = {10}^{- 6} \cdot {\sum }_{j = 1}^{J} ( {v}_{Layers}^{( j )} \cdot {Q}_{m}^{( j )} \cdot {f}^{( j )} \cdot {R}_{max} \cdot \frac{{N}_{P R B}^{BW ( j ) , μ} \cdot 12}{{T}_{s}^{μ}} \cdot ( 1 - O {H}^{( j )} ) )$$

wherein

J is the number of aggregated component carriers in a band or band combination:

$${R}_{max} = 948 / 1024$$

For the j-th CC,
v_{Layers}^{(j)} is the maximum number of supported layers given by higher layer parameter maxNumberMIMO-LayersPDSCH for downlink and maximum of higher layer parameters maxNumberMIMO-LayersCB-PUSCH and maxNumberMIMO-LayersNonCB-PUSCH for uplink;
Qₘ^{(j)} is the maximum supported modulation order given by higher layer parameter supportedModulationOrderDL for downlink and higher layer parameter supportedModulationOrderUL for uplink, wherein supportedModulationDL=1024QAM when WD 22 indicates 1024QAM support for a band;
f^{(j)} s the scaling factor given by higher layer parameter scalingFactor1024-r17 if (pdsch-1024QAM-FR1/is signalled and by higher layer parameter scalingFactor otherwise, and can take the values 1, 0.8, 0.75, and 0.4:
μ is the numerology (as defined in 3GPP TS 38.211);
Tₛ^{μ} is the average OFDM symbol duration in a subframe for numerology μ, i.e.

$${T}_{s}^{μ} = \frac{1 {0}^{- 3}}{14 \cdot {2}^{μ}} .$$

Note that normal cyclic prefix is assumed;
N_{PRB}^{BW(j),μ} is the maximum RB allocation in bandwidth BW^{(j)} with numerology μ, as defined in 5.3 TS 38.101-1 and 5.3 TS 38.101-2, where BW^{(j)} is the WD 22 supported maximum bandwidth in the given band or band combination;
OH^{(j)} is the overhead and takes the following values:
   0.14, for frequency range FR1 for DL
   0.18, for frequency range FR2 for DL
   0.08, for frequency range FR1 for UL
   0.10, for frequency range FR2 for UL

NOTE 1: Only one of the UL or SUL carriers (the one with the higher data rate) is counted for a cell operating SUL.

NOTE 2: For UL Tx switching between carriers, only the supported MIMO layer combination across carriers that results in the highest combined data rate is counted for the carriers in the supported maximum UL data rate.

A corresponding text proposal to update the supported maximum data rate calculation is shown below, wherein the proposed changes are in bold underline. However it is understood each of the following change could be separately applied.
for downlink, Qₘ^{(j)} is the modulation order signalled per band, i.e. [pdsch-1024QAM-FR1] if [pdsch-1024QAM-FR1] is signalled, and is the maximum supported modulation order given by higher layer parameter supportedModulationOrderDL otherwise. for uplink, Qₘ^{(j)} is the maximum supported modulation order given by higher layer parameter supportedModulationOrder UL for uplink:
f^{(j)} is the scaling factor given by higher layer parameter scalingFactor 1024-r17 if (pdsch-1024QAM-FR1] is signalled and by higher layer parameter scaling Factor otherwise, and can take the values 1, 0.8, 0.75, and 0.4.

For NR, the approximate data rate for a given number of aggregated carriers in a band or band combination is computed as follows.

$$data rate ( in Mbps ) = {10}^{- 6} \cdot {\sum }_{j = 1}^{J} ( {v}_{Layers}^{( j )} \cdot {Q}_{m}^{( j )} \cdot {f}^{( j )} \cdot {R}_{max} \cdot \frac{{N}_{P R B}^{BW ( j ) , μ} \cdot 12}{{T}_{s}^{μ}} \cdot ( 1 - O {H}^{( j )} ) )$$

wherein

J is the number of aggregated component carriers in a band or band combination

$${R}_{max} = 948 / 1024 ;$$

For the j-th CC:
v_{Layers}^{(j)} is the maximum number of supported layers given by higher layer parameter maxNumberMIMO-LayersPDSCH for downlink and maximum of higher layer parameters maxNumberMIMO-LayersCB-PUSCH and maxNumberMIMO-LayersNonCB-PUSCH for uplink;
for downlink, Qₘ^{(j)} is the modulation order signalled per band, i.e. [pdsch-1024QAM-FR1] if Ipdsch-1024QAM-FR1] is signalled, and is the maximum supported modulation order given by higher layer parameter supportedModulationOrderDL otherwise;
for uplink, Qₘ^{(j)} is the maximum supported modulation order given by higher layer parameter supportedModulationOrderUL for uplink;
f^{(j)} is the scaling factor given by higher layer parameter scalingFactor1024QAM-r17 if (pdsch-1024QAM-FR1] is signalled and by higher layer parameter scalingFactor otherwise, and can take the values 1, 0.8, 0.75, and 0.4;
μ is the numerology (as defined in 3GPP TS 38.211);
Tₛ^{μ} is the average OFDM symbol duration in a subframe for numerology μ, i.e.

$${T}_{s}^{μ} = \frac{1 {0}^{- 3}}{14 \cdot {2}^{μ}} .$$

Note that normal cyclic prefix is assumed;
N_{PRB}^{BW(j),μ} is the maximum RB allocation in bandwidth BW^{(j)} with PRB numerology μ, as defined in 5.3 3GPP TS 38.101-1 and 5.3 3GPP TS 38.101-2, where BW^{(j)} is the WD 22 supported maximum bandwidth in the given band or band combination;
OH^{(j)} is the overhead and takes the following values:
   0.14, for frequency range FR1 for DL
   0.18, for frequency range FR2 for DL
   0.08, for frequency range FR1 for UL
   0.10, for frequency range FR2 for UL

NOTE 1: Only one of the UL or SUL carriers (the one with the higher data rate) is counted for a cell operating SUL.

NOTE 2: For UL Tx switching between carriers, only the supported MIMO layer combination across carriers that results in the highest combined data rate is counted for the carriers in the supported maximum UL data rate.

Some embodiments provide a new capability to disambiguate the PT-RS density recommendation when WD 22 reports support of both 1024-QAM and 256-QAM, or just a new capability applicable for 1024-QAM case.

Some embodiments provide a new capability to disambiguate the data rate scaling factor and/or value of supportedModulationOrderDL to apply when WD 22 reports capability of supporting both 1024-QAM and 256-QAM.

According to one aspect, a network node is configured to communicate with a wireless device (WD) 22. The network node includes a radio interface 62 and/or processing circuitry 68 configured to: receive a first indication of a first maximum order of a quadrature amplitude modulation, QAM, capability of the WD 22 for a first band and a second indication of a second maximum order of a QAM capability of the WD 22 for a second band; and disambiguate a phase tracking reference signal, PTRS, based on the first indication and the second indication.

According to this aspect, in some embodiments, the processing circuitry 68 is further configured to configure the WD 22 with a scaling factor to be applied in performing QAM. In some embodiments, the scaling factor indicates an order of QAM to be applied by the WD 22.

According to another aspect, a method implemented in a network node 16 includes receiving a first indication of a first maximum order of a quadrature amplitude modulation, QAM, capability of the WD 22 for a first band and a second indication of a second maximum order of a QAM capability of the WD 22 for a second band; and disambiguating a phase tracking reference signal, PTRS, based on the first indication and the second indication.

According to this aspect, in some embodiments, the method further includes receiving and applying a scaling factor for performing QAM. In some embodiments, the scaling factor indicates an order of QAM to be applied by the WD 22.

According to yet another aspect, a wireless device (WD) 22 is configured to communicate with a network node. The WD 22 includes comprising a radio interface 82 and/or processing circuitry 84 configured to: transmit a first indication of a first maximum order of a quadrature amplitude modulation, QAM, capability of the WD 22 for a first band and a second indication of a second maximum order of a QAM capability of the WD 22 for a second band; and receive and apply a scaling factor for performing QAM.

According to this aspect, in some embodiments, the scaling factor is based on disambiguating a phase tracking reference signal, PTRS, based on the first indication and the second indication. In some embodiments, the scaling factor indicates an order of QAM to be applied by the WD 22.

According to another aspect, a method implemented in a wireless device (WD) 22 includes transmitting a first indication of a first maximum order of a quadrature amplitude modulation, QAM, capability of the WD 22 for a first band and a second indication of a second maximum order of a QAM capability of the WD 22 for a second band; and receiving and applying a scaling factor for performing QAM.

According to this aspect, in some embodiments, the scaling factor is based on disambiguating a phase tracking reference signal, PTRS, based on the first indication and the second indication. In some embodiments, the scaling factor indicates an order of QAM to be applied by the WD 22.

Some embodiments may include one or more of the following:

Embodiment A1. A network node configured to communicate with a wireless device (WD), the network node configured to, and/or comprising a radio interface and/or comprising processing circuitry configured to:
receive a first indication of a first maximum order of a quadrature amplitude modulation, QAM, capability of the WD for a first band and a second indication of a second maximum order of a QAM capability of the WD for a second band; and
disambiguate a phase tracking reference signal, PTRS, based on the first indication and the second indication.

Embodiment A2. The network node of Embodiment A1, further comprising configuring the WD with a scaling factor to be applied in performing QAM.

Embodiment A3. The network node of Embodiment A2, wherein the scaling factor indicates an order of QAM to be applied by the WD.

Embodiment B1. A method implemented in a network node, the method comprising:
receiving a first indication of a first maximum order of a quadrature amplitude modulation, QAM, capability of the WD for a first band and a second indication of a second maximum order of a QAM capability of the WD for a second band; and
disambiguating a phase tracking reference signal, PTRS, based on the first indication and the second indication.

Embodiment B2. The method of Embodiment B1, further comprising receiving and applying a scaling factor for performing QAM.

Embodiment B3. The method of Embodiment B2, wherein the scaling factor indicates an order of QAM to be applied by the WD.

Embodiment C1. A wireless device (WD) configured to communicate with a network node, the WD configured to, and/or comprising a radio interface and/or processing circuitry configured to:
transmit a first indication of a first maximum order of a quadrature amplitude modulation, QAM, capability of the WD for a first band and a second indication of a second maximum order of a QAM capability of the WD for a second band; and
receive and apply a scaling factor for performing QAM.

Embodiment C2. The WD of Embodiment C1, wherein the scaling factor is based on disambiguating a phase tracking reference signal, PTRS, based on the first indication and the second indication.

Embodiment C3. The WD of Embodiment C1, wherein the scaling factor indicates an order of QAM to be applied by the WD.

Embodiment D1. A method implemented in a wireless device (WD), the method comprising:
transmitting a first indication of a first maximum order of a quadrature amplitude modulation, QAM, capability of the WD for a first band and a second indication of a second maximum order of a QAM capability of the WD for a second band; and
receiving and applying a scaling factor for performing QAM.

Embodiment D2. The method of Embodiment D1, wherein the scaling factor is based on disambiguating a phase tracking reference signal, PTRS, based on the first indication and the second indication.

Embodiment D3. The method of Embodiment D1, wherein the scaling factor indicates an order of QAM to be applied by the WD.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
BWP Bandwidth Part
CC Component carrier
DSS Dynamic Spectrum Sharing
DL Downlink
eMBB enhanced Mobile BroadBand
FDD Frequency Division Duplex
LTE Long Term Evolution
NR New Radio
PDCCH Physical Downlink Control Channel
PDSCH Physical Downlink Shared Channel
PTRS Phase Tracking Reference Signal
PUSCH Physical Uplink Shared Channel
SCS Subcarrier Spacing
SRS Sounding Reference Signal
TBS Transport Block Size
TDD Time Division Duplex
UE User Equipment
UL Uplink

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method in a network node configured to communicate with a wireless device, WD, the method comprising:
receiving from the WD an indication of one of a first scaling factor and a second scaling factor, the first scaling factor corresponding to a first modulation order and a first data rate, and the second scaling factor corresponding to a second modulation order and a second data rate;
receiving from the WD one of a first phase tracking reference signal, PTRS, density recommendation and a second PTRS density recommendation, the first PTRS density recommendation associated with the first modulation order, the second PTRS density recommendation associated with the second modulation order;
selecting one of the first modulation order and the second modulation order based at least in part on the indicated one of the first scaling factor and the second scaling factor; and
transmitting to the WD a control message, the control message indicating the selected one of the first and second modulation order and a corresponding one of the first and second data rate, the second modulation order being 1024-QAM.

2. The method of claim 1, wherein the control message is transmitted by radio resource control, RRC, signaling, the signaling configured to include one of a first parameter and a second parameter, the first parameter indicating 1024 quadrature amplitude modulation, QAM, capability of the WD, the second parameter indicating a different order of modulation.

3. The method of claim 1, further comprising determining a data rate corresponding to the indicated one of the first scaling factor and the second scaling factor.

4. (canceled)

5. The method of claim 1, further comprising transmitting to the WD a set of threshold values corresponding to different subcarrier spacings, SCSs, for determining PTRS density for a physical downlink shared channel, the set of threshold values being associated with one of the first and second modulation order.

6. A network node configured to communicate with a wireless device, WD, the network node comprising:
a radio interface configured to:
receive from the WD an indication of one of a first scaling factor and a second scaling factor, the first scaling factor corresponding to a first modulation order and a first data rate, and the second scaling factor corresponding to a second modulation order and a second data rate; and
receive from the WD one of a first phase tracking reference signal, PTRS, density recommendation and a second PTRS density recommendation, the first PTRS density recommendation associated with the first modulation order, the second PTRS density recommendation associated with the second modulation order;
processing circuitry in communication with the radio interface and configured to select one of the first modulation order and the second modulation order based at least in part on the indicated one of the first scaling factor and the second scaling factor; and
the radio interface being further configured to transmit to the WD a control message, the control message indicating the selected one of the first and second modulation order and a corresponding one of the first and second data rate, the second modulation order being 1024-QAM.

7. The network node of claim 6, wherein the control message is transmitted by radio resource control, RRC, signaling, the signaling configured to include one of a first parameter and a second parameter, the first parameter indicating 1024 quadrature amplitude modulation, QAM, capability of the WD, the second parameter indicating a different order of modulation.

8. The network node of claim 6, wherein the processing circuitry is further configured to determine a data rate corresponding to the indicated one of the first scaling factor and the second scaling factor.

9. (canceled)

10. The network node of claim 6, wherein the radio interface is further configured to transmit to the WD a set of threshold values corresponding to different subcarrier spacings, SCSs, for determining PTRS density for a physical downlink shared channel, the set of threshold values being associated with one of the first and second modulation order.

11. A method in a wireless device, WD, configured to communicate with a network node, the method comprising:
transmitting to the network node an indication of one of a first scaling factor and a second scaling factor, the first scaling factor corresponding to a first modulation order and a first data rate, and the second scaling factor corresponding to a second modulation order and a second data rate;
transmitting to the network node one of a first phase tracking reference signal, PTRS, density recommendation and a second PTRS density recommendation, the first PTRS density recommendation associated with the first modulation order, the second PTRS density recommendation associated with the second modulation order;
receiving a control message, the control message indicating one of the first and second modulation order and corresponding one of the first and second data rate; and
demodulating a physical downlink shared channel using the indicated one of the first and second modulation order, the second modulation order being 1024-QAM.

12. The method of claim 11, wherein the control message is received by radio resource control, RRC, signaling, the signaling configured to include one of a first parameter and a second parameter, the first parameter indicating 1024 quadrature amplitude modulation, QAM, capability of the WD, the second parameter indicating a different order of modulation.

13. The method of claim 11, further comprising determining a data rate corresponding to the indicated one of the first scaling factor and the second scaling factor.

14. (canceled)

15. The method of claim 11, further comprising receiving from the network node a set of threshold values corresponding to different subcarrier spacings, SCSs, for determining PTRS density for a physical downlink shared channel, the set of threshold values being associated with one of the first and second modulation order.

16. A wireless device, WD, configured to communicate with a network node, the WD comprising:
a radio interface configured to:
transmit to the network node an indication of one of a first scaling factor and a second scaling factor, the first scaling factor corresponding to a first modulation order and a first data rate, and the second scaling factor corresponding to a second modulation order and a second data rate; and
to transmit to the network node one of a first phase tracking reference signal, PTRS, density recommendation and a second PTRS density recommendation, the first PTRS density recommendation associated with the first modulation order, the second PTRS density recommendation associated with the second modulation order;
receive a control message, the control message indicating one of the first and second modulation order and a corresponding one of the first and second data rate; and
processing circuitry in communication with the radio interface and configured to demodulate a physical downlink shared channel using the indicated one of the first and second modulation order at the corresponding one of the first and second data rate, wherein the second modulation order being 1024-QAM.

17. The WD of claim 16, wherein the control message is received by radio resource control, RRC, signaling, the signaling configured to include one of a first parameter and a second parameter, the first parameter indicating 1024 quadrature amplitude modulation, QAM, capability of the WD, the second parameter indicating a different order of modulation.

18. The WD of claim 16, wherein the processing circuitry is further configured to determine a data rate corresponding to the indicated one of the first scaling factor and the second scaling factor.

19. (canceled)

20. The WD of claim 16, wherein the radio interface is further configured to receive from the network node a set of threshold values corresponding to different subcarrier spacings, SCSs, for determining PTRS density for a physical downlink shared channel, the set of threshold values being associated with one of the first and second modulation order.
